(19) United States
(12) Patent Application Publication
(10) Pub. No.: US 2006/0161673 A1
(43) Pub. Date: Jul. 20, 2006

(54) Routing apparatus and method for 6to4 network

(76) Inventors: Se-Woong Moon, Yongin-si (KR); Byung-Chang Kang, Yongin-si (KR); Yong-Seok Park, Yongin-si (KR)

Correspondence Address: Robert E. Bushnell, Suite 300, 1522 K Street, N.W., Washington, DC, 20005, US

(21) Appl. No.: 11/333,224

(22) Filed: Jan. 18, 2006

(30) Foreign Application Priority Data
Jan. 18, 2005 (KR) 10-2005-0004761

(51) Int. Cl. G06F 15/16; G06F 15/173

(52) U.S. Cl. 709/230; 709/238

(57) ABSTRACT

This invention relates to a routing apparatus and to a routing method in a network system in which a 6to4 network is connected to a native IPv6 network. An optimum transmission route is selected by considering the topology of the 6to4 network and the topology of the native IPv6 network. One embodiment of the routing apparatus comprises an information collector, a message generator and a message transmitter. Another embodiment of the routing apparatus comprises a routing information collector, a message receiver, and a route selector. The network system comprises a 6to4 relay router and a 6to4 router. The method comprises collecting routing information of the native IPv6 network and the 6to4 network, respectively, and selecting the route based on the collected information. Finally, a message used for transmitting the routing information comprises a Border Gateway Protocol (BGP) update message.

### CLAIM OF PRIORITY

This application makes reference to, incorporates the same herein, and claims all benefits accruing under 35 U.S.C.§119 from an application for ROUTING APPARATUS AND METHOD FOR 6to4 NETWORK earlier filed in the Korean Intellectual Property Office on 18 Jan. 2005 and there duly assigned Serial No. 10-2005-0004761.

### BACKGROUND OF THE INVENTION

1. Technical Field

The present invention relates to a routing apparatus and a routing method for allowing selection of an optimum transmission route in a network system where an Internet Protocol version 6 (IPv6) network coexists with an Internet Protocol version 4 (IPv4) network.

2. Related Art

IPv6 protocol is a next generation of Internet protocol having a 128 bit address system, proposed to overcome a problem of address shortage occurring in an IPv4 protocol having a 32 bit address system. We are presently in a transition stage wherein IPv4 networks are being changed into IPv6 networks, and the IPv6 and IPv4 networks coexist together. Therefore, at present, there are networks connecting between IPv6 and IPv4 networks, and sometimes IPv6 traffic has to be transmitted via an IPv4 network. Such a network for connecting between the IPv6 and IPv4 networks is referred to as 6to4 network, in which IPv6 packets are delivered via the IPv4 network. The technology standard for the delivery of IPv6 traffic via IPv4 networks is referred to as a 6to4 transition protocol. The transmission of IPv6 traffic via an IPv4 network can be enabled through tunneling and routing with respect to corresponding traffic. A scenario related to this is mentioned in “RFC 3056 Connection of IPv6 Domains via IPv4 Clouds.” In the meantime, a network constituted of only IPv6 network components such as an IPv6 router unlike the 6to4 network is referred to as “native IPv6 network.”

FIG. 1 illustrates a network system in which an IPv6 network is connected to a 6to4 network.

As shown in FIG. 1, 6to4 routers 120 and 6to4 relay routers 140 are located on the border of a 6to4 network.

The 6to4 routers 120 are used to connect IPv6 hosts 100-1 and 100-2 to the IPv4 network. That is, through tunneling, the 6to4 routers 120 enable IPv6 packets directed from or toward the IPv6 hosts 100-1 and 100-2 to be transmitted to a destination via the IPv4 network. The IPv4 network shown in FIG. 1 is the 6to4 network which the IPv6 packets pass through.

The 6to4 relay routers 140 are used for the connection of the 6to4 network to the native IPv6 network. That is, the 6to4 relay routers 140 can be said to be located on the border of the 6to4 network and the native IPv6 network.

A tunnel for transmitting IPv6 packets is established between a 6to4 router 120 and a 6to4 relay router 140, passing through the 6to4 network. Packet transmission in the IPv6 network after the 6to4 relay routers 140 is performed according to IPv6 routing protocol.

In the network system as shown in FIG. 1, dynamic routing for communication between a 6to4 network host and a native IPv6 network host can be performed as follows.

All the 6to4 routers 120 in a 6to4 site use internal Border Gateway Protocol (iBGP) to receive, from the 6to4 relay routers 140, route information which is selected according to the topology of the native IPv6. Through this process, the 6to4 routers 120 can select a route by reflecting the topology of the native IPv6 network. In this case, route information received at the 6to4 routers 120 from the 6to4 relay routers 140 is selected based upon topology information until the BGP protocol itself reaches its Autonomous System (AS). Thus, topology information from the 6to4 routers 120 to the 6to4 relay routers 140 is not considered. This problem will be described with reference to FIG. 1.

Components shown in FIG. 1 are assumed to have respective network addresses as listed in Table 1. In this case, Table 1 reports only those network addresses corresponding to some of the components in FIG. 1, which will be mentioned in the following description.

TABLE 1

| Title | Network address |
|---|---|
| Host 1 (100-1) | 2002:0b0b:0b0b:0000::0011 |
| Host 2 (100-2) | 2002:0b0b:0b0b:0000:/48 |
| Host 3 (100-3) | 2ffe:0001::/32 |
| 6to4 site 1 (110-1) | 2002:0b0b:0b0b:0000:/48 |
| 6to4 site 1 (110-2) | 2002:2121:2121::/64 |
| IPv6 site (110-3) | 2ffe:0001::32 |
| 6to4 router 1 (120-1) | 2002:0b0b:0b0b:0000::0001/64 |
| 6to4 relay router 1 (140-1) | 192.88.99.1/24 |
| 6to4 relay router 2 (140-2) | 192.88.99.2/24 |

Tables 2 and 3 show an example of routing information which the 6to4 router 120-1 and the 6to4 router 120-2 acquire according to routing protocol for the purpose of selecting a route for the host 100-3. In this case, metric values marked in Tables 2 and 3 are calculated based on the assumption that a metric value “1” is assigned equally to all inter-router movement in the network system as shown in FIG. 1.

TABLE 2

| <BGP RIB> | prefix | nexthop | select |
|---|---|---|---|
| | 2ffe:0001::/32 | ::192.88.99.1 | * |
| | 2ffe:0001::/32 | ::192.88.99.2 | |
| <IPv4 RIB> | prefix | nexthop | metric |
| | 192.88.99.1/32 | 11.11.11.1 | 3 |
| | 192.88.99.2/32 | 11.11.11.1 | 3 |
| <IPv6 RIB> | prefix | nexthop | interface |
| | 2ffe:0001::/32 | ::192.88.99.1 | 6to4 |

Table 2 shows an example of routing information which the 6to4 router 120-1 acquires in the process of selecting a route from the host 100-1 to the host 100-3. Route selection or routing for traffic transmission from the host 100-1 to the host 100-3 will be described with reference to Table 2.

Referring to IPv6 Routing Information Base (RIB) items first, it is seen that the 6to4 relay router 140-1 is selected from the 6to4 relay routers 140-1 and 140-2. This selection is made according to a routing protocol in the IPv6 network since a route from the 6to4 relay router 140-1 via an IPv6 router 150-5 and an IPv6 router 150-3 to an IPv6 router 150-2 has a metric value of “3”, which is smaller than the value “4” for a route from the 6to4 relay router 140-2 via an IPv6 router 150-6, an IPv6 router 150-4 and the IPv6 router 150-3 to the IPv6 router 150-2.

As a result of routing in the native IPv6 network, the value of the 6to4 relay router 140-1 is set to a default value, and thus routing is set to the 6to4 relay router 140-1 regardless of the topology in the 6to4 network.

When such routing is set as above, there is no problem in routing from the host 100-1 to the host 100-3 since the route from the 6to4 router 120-1 to the 6to4 relay router 140-1 has the same metric value “3” as the route from the 6to4 router 120-1 to the 6to4 relay router 140-2. That is, when routing from the host 100-1 to the host 100-3, the route passing through the 6to4 relay router 140-1 has a smaller metric value than the route passing through the 6to4 relay router 140-2. Thus, the 6to4 relay router 140-1 is preferably selected as described above. However, routing sometimes disadvantageously selects an inefficient route having a larger metric value.

Such a problem in routing will be described with reference to Table 3 below.

TABLE 3

| <BGP RIB> | prefix | nexthop | select |
|---|---|---|---|
| | 2ffe:0001::/32 | ::192.88.99.1 | * |
| | 2ffe:0001::/32 | ::192.88.99.2 | |
| <IPv4 RIB> | prefix | nexthop | metric |
| | 192.88.99.1/32 | 33.33.33.1 | 4 |
| | 192.88.99.2/32 | 33.33.33.1 | 2 |
| <IPv6 RIB> | prefix | nexthop | interface |
| | 2ffe:0001::/32 | ::192.88.99.1 | 6to4 |

Table 3 shows an example of routing information which the 6to4 router 120-2 acquires when routing from the host 100-2 to the host 100-3. The 6to4 relay router 140-1 is also selected in this case. However, in this case, the route from the 6to4 router 120-2 to the 6to4 relay router 140-1 has a metric value of “4” but another route from the 6to4 router 120-2 to the 6to4 relay router 140-2 has a metric value of “2.” Thus, the route passing through the 6to4 relay router 140-1, which is selected by this process, has a larger metric value than the route passing through the 6to4 relay router 140-2.

That is, when connecting the 6to4 network to the native IPv6 network, the routing process selects a route for traffic transmission by merely considering the topology of the native IPv6 network without considering the topology of the 6to4 network, and thus it cannot realize efficient routing.

### SUMMARY OF THE INVENTION

The present invention has been developed to solve the problems of prior routing systems and methods and it is therefore an object of the present invention to provide a routing apparatus and a routing method which can select an optimum transmission route in a network system, wherein an Internet Protocol version 6 (VPv6) network coexists with an Internet Protocol version 4 (IPv4) network, by considering both of IPv6 and IPv4 network topologies.

According to an aspect of the invention for realizing the above objects, there is provided a routing apparatus in a 6to4 relay router, which connects a native IIPv6 network with a 6to4 network, for selecting a route passing through the IPv6 and 6to4 networks, the apparatus comprising: an information collector for collecting routing information of the native IPv6 network; a message generator for generating a message including the collected routing information; and a message transmitter for transmitting the message to a 6to4 router of the 6to4 network.

According to another aspect of the invention for realizing the above objects, there is provided a routing apparatus in a 6to4 relay router, which connects a native IPv6 network to a 6to4 network, for selecting a route passing through the IPv6 and 6to4 networks, the apparatus comprising: a routing information collector for collecting routing information of the 6to4 network; a message receiver for receiving the routing information of the IPv6 network from the 6to4 relay router connecting the native IPv6 network to the 6to4 network; and a route selector for selecting a route for a network connected to the native IPv6 network and the 6to4 network according to routing information of the 6to4 network and the received routing information of the native IPv6 network.

According to a further aspect of the invention for realizing the above objects, there is provided a network system in which a route passing through a native IPv6 network and a 6to4 network is selected, the system comprising: a 6to4 relay router located on a border between the native IPv6 network and the 6to4 network, and adapted to collect routing information of the native IPv6 network, for transmitting the collected routing information; and a 6to4 router located in the 6to4 network, and adapted to collect routing information of the 6to4 network, for selecting a route for traffic transmission between the native IPv6 network and the 6to4 network according to the collected routing information of the 6to4 network and the routing information of the native IP6 network received from the 6to4 relay router.

According to another aspect of the invention for realizing the above objects, there is provided a message in use for transmitting routing information between a 6to4 router and a 6to4 relay router, and for selecting a route passing through a native IPv6 network and a 6to4 network, the message being a BGP update message comprising routing information of the native IPv6 network collected by a 6to4 relay router.

According to yet another aspect of the invention for realizing the above objects, there is provided a routing method for a 6to4 network, for selecting a route passing through a native IPv6 network and the 6to4 network, the method comprising the steps of:

(a) collecting routing information of the native IPv6 network;

(b) collecting routing information of the 6to4 network; and

(c) selecting a route passing through the native IPv6 network and the 6to4 network according to the routing information of the native IPv6 network and the routing information of the 6to4 network.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a network system in which an IPv6 network is connected to a 6to4 network;

FIG. 2 illustrates a BGP open message format, including option fields which contain router identification information in accordance with the invention;

FIG. 3 illustrates an UPDATE message format used for information transmission between a 6to4 relay router and a 6to4 router;

FIG. 4 illustrates a route property field in the UPDATE message shown in FIG. 3; and

FIG. 5 illustrates a network system to which a routing apparatus capable of selecting an optimum route is applied according to the invention.

### DETAILED DESCRIPTION OF THE INVENTION

The following detailed description will present preferred embodiments of the present invention with reference to the accompanying drawings, in which well-known functions or components will not be described if they unnecessarily obscure the concept of the invention.

In the following description of the invention, when attaching reference signs to components shown in the accompanying drawings, plural components of the same function will be marked discriminatively, such as “host 100-1” and “host 100-2.” In addition, when referring to these components, they may be discriminatively mentioned, for example, as “host 100-1” and “host 100-2” if necessary, or generally mentioned, for example, as “host 100”, if discriminative description is not necessary.

According to the technical features of the invention, the routing apparatus and method of the invention are adapted to expand current Border Gateway Protocol (BGP), and to select an optimum route by considering both a native IPv6 topology collected according to the expanded BGP and a 6to4 network topology collected from a 6to4 network.

The present invention adopts, as basic components, a 6to4 router and a 6to4 relay router, which are described in “RFC 3056 Connection of IPv6 Domains via IPv4 Clouds”. The invention adds functions proposed by the invention to BGP and Internal Gateway Protocol (IGP) functions between the 6to4 router and the 6to4 relay router.

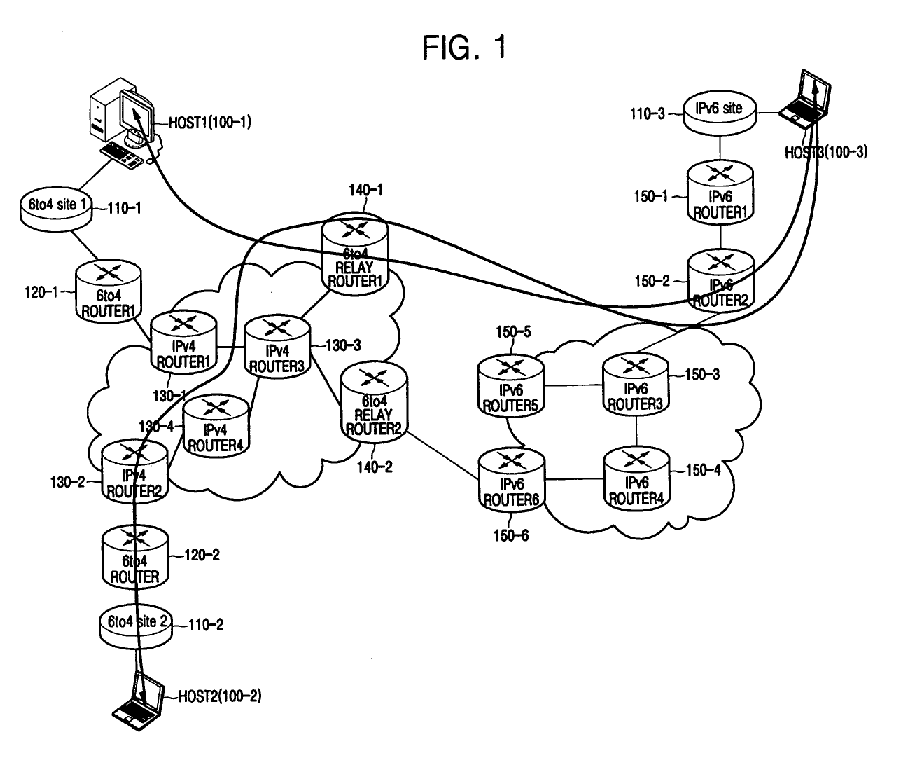

FIG. 1 illustrates a network system in which an IPv6 network is connected to a 6to4 network, and more specifically, a network system to which a routing apparatus capable of selecting an optimum route is applied according to the invention.

As shown in FIG. 1, the invention can be applied to a network system in which a native IPv6 network is connected to a 6to4 network which allows IPv6 packets to be transmitted via an IPv4 network.

The network system shown in FIG. 1 can be generally divided into the 6to4 network and the native IPv6 network. Each network includes at least one router, and provides a communication service via a transmission route that passes through the router.

The 6to4 network includes at least one 6to4 router 120, at least one IPv4 router 130 and at least one 6to4 relay router 140, and can be connected to hosts 100-1 and 100-2 via the 6to4 router 120. The hosts 100-1 and 100-2 are hosts attempting to transmit IPv6 traffic via the IPv4 network, and may have an address starting with “2002:.”

In the native IPv6 network shown in FIG. 1, traffic transmission is performed via typical IPv6 routing. In the 6to4 network, traffic transmission is performed via tunneling. In FIG. 1, a tunnel for transmitting IPv6 traffic via the IPv4 network is established between the 6to4 router 120 and the 6to4 relay router 140.

The 6to4 relay router 120 acts as a gateway between the host 100-1 or 100-2 of the 6to4 network and a host 100-3 of the IPv6 network. The 6to4 relay router 140 allows the 6to4 network to be connected to the native IPv6 network. Specifically, in accordance with the invention, the 6to4 relay router 140 collects routing information, which reflects the topology of the native IPv6 network, by using a routing protocol, such as IGP. BGP is a type of pass vector routing protocol, and can be used for both the External Gateway Protocol (EGP) and the IGP. The BGP used for IGP is also referred to as iBGP. BGP is a routing protocol used by the 6to4 relay router 140 to confirm the network information of the native IPv6 network, and is so constituted as to be used in the IPv6 network. Also, detailed information of the BGP can be confirmed by RFC 2858, RFC 2545, and so on. In addition, a basic protocol of the BGP can be confirmed by RFC 1771. Each protocol will not be described in detail herein.

The 6to4 relay router 140 transmits information, which includes the routing information of the native IPv6 network collected as above, used routing protocol and so on, to the 6to4 router 120. In order to execute such functions, the 6to4 relay router 140 may have a routing apparatus. The routing apparatus includes a routing information collector for collecting the routing information of the native IPv6 network, a message generator for generating a message containing the collected routing information, and a message transmitter for transmitting the message to the 6to4 router. The routing apparatus may further include a memory for storing the routing information or route information selected according to the routing information. In this case, this information is generally stored in a table.

The 6to4 router 120 performs tunneling and de-tunneling functions in order to transmit traffic from the 6to4 network via the IPv4 network. The 6to4 router 120 can receive the routing information of the native IPv6 network from the relay router 140 according to internal Border Gateway Protocol (iBGP). The 6to4 router 120 can execute tunneling for transmission of traffic, which passes through the 6to4 network and the native IPv6 network according to the routing information received from the 6to4 relay router 140. Of course, the 6to4 router 120 collects the routing information of the 6to4 network according to a routing protocol, such as IGP, and selects a route in the 6to4 network according to the collected routing information. The 6to4 router 120 searches for a destination for the purpose of tunneling according to the routing information of the native IPv6 network received from the 6to4 relay router 140 and the routing information of the 6to4 network collected by itself.

The 6to4 router 120 of the invention may have a routing apparatus. The routing apparatus includes a message receiver for receiving from the router 140 a message containing the routing information of the native IPv6 network, a routing information collector for collecting the routing information of the 6to4 network, and a route selector for selecting a route passing through the native IPv6 network and the 6to4 network according to the routing information of the native IPv6 network received from the 6to4 relay router 140 and the routing information of the 6to4 network collected by the routing information collector.

The route selector of the 6to4 router is adapted to select a route of a minimum metric value from available routes that pass through the native IPv6 network and the 6to4 network.

The routing apparatus may further include a memory for storing the routing information and route information which is set according to the routing information.

With the afore-described routing apparatus, the 6to4 router 120 can select an optimum transmission route by reflecting the topology of the native IPv6 network.

Since the invention relates to route selection for traffic transmission rather than traffic transmission itself via routers, traffic transmission will not be described in detail.

A message transmitted between routers of the invention will be described as follows, but it should be noted that the following description will be made with reference to an embodiment which uses BGP as a routing protocol.

An iBGP session 1 is established between the 6to4 relay router 140-1 and the 6to4 relay router 140-2. The 6to4 relay routers 140-1 and 140-2 contain the routing information of the native IPv6 network collected according to the IPv6 routing protocol. An IPv6 neighbor establishing process utilizes substantially the same sequence as FRC 1771. However, since the message format defined by RFC 1771 cannot distinguish between the 6to4 router 120 and the 6to4 relay router 140, this information is added to an option field of an OPEN message.

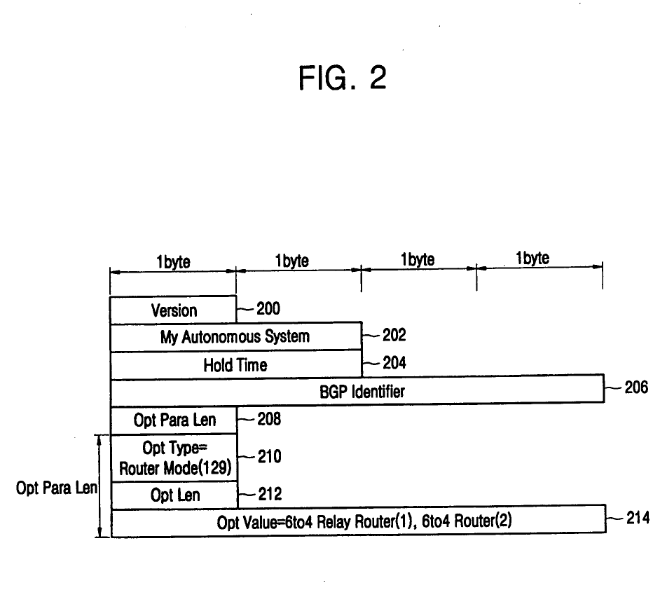

FIG. 2 illustrates a BGP open message format, including option fields which contain router identification information in accordance with the invention.

As shown in FIG. 2, the BGP open message of the present invention includes a version information field 200, an autonomous system identifier field 202, a hold time field 204, and a BGP identifier field 206, together with an option field containing router identification information. While FIG. 2 illustrates the BGP open message, including option fields exclusively containing router identification information in use for the invention, the invention is not limited thereto, and the option fields can contain other necessary information.

The option fields 208 to 214 of the BGP open message can be constituted, in particular, to include option parameter length 208, option type 210, option length 212 and option value 214. The option parameter length 208 contains whole length information of the option parameters of the option type 210, the option length 212 and the option value 214. The option type 210 designates the information of the corresponding option value 214, and the option length 212 designates the length of the corresponding option value 214. In the BGP open message as shown in FIG. 2, the option fields 208 to 214 show that corresponding option fields are used to represent router type. If the corresponding router of FIG. 2 is the 6to4 relay router 140, the option value 214 will be set “1.” If the corresponding router is the 6to4 router 120, the option value 214 will be set “2.”

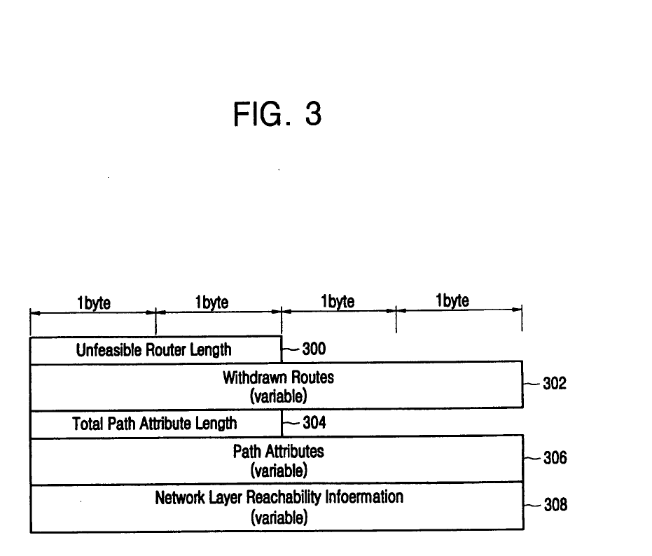

The 6to4 relay router 140-1 and the 6to4 relay route 140-2 acquire the routing information of the native IPv6 network according to IGP or BGP on the IPv6 network. When acquired like this, according to acquired methods, the routing information is transmitted to the 6to4 router 120-1 and the 6to4 router 120-2, together with a route selected by corresponding routing protocol. Such information can be transmitted in a message having a format as shown in FIG. 3.

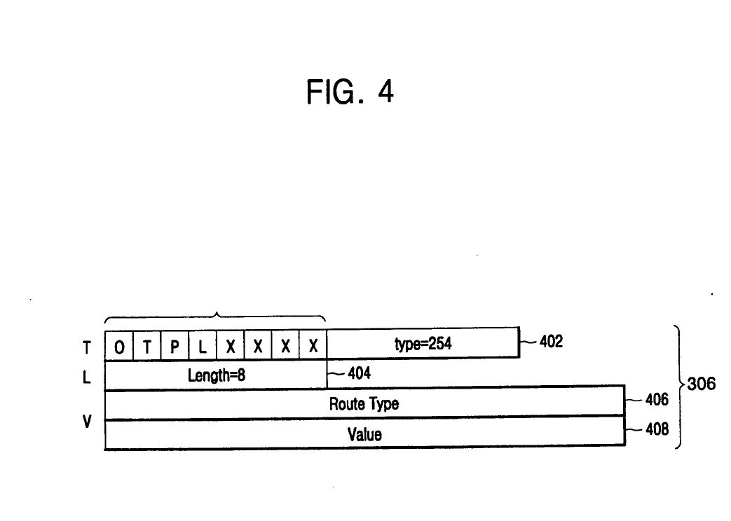

FIG. 3 illustrates an UPDATE message format used for information transmission between a 6to4 relay router and a 6to4 router; and FIG. 4 illustrates a route property field in the UPDATE message shown in FIG. 3.

Route type field 406 in FIG. 4 contains route type information according to routes. Examples of route type may include Routing Information Protocol (RIP), Open Shortest Path First (OSPF), Intermediate System to Intermediate System (IS-IS), and so on. That is, route type information indicates the type of routing protocol used for routing. Value field 408 may contain routing information collected by using a corresponding routing protocol. Examples of routing information containing value field 408 may include metric, cost and so on.

Hereinafter the operation of the invention will be described with reference to FIGS. 1 to 4. The operation of the 6to4 relay router 140 will be first described.

The 6to4 relay router 140 uses IGP protocol (e.g., iBGP) for IPv6 to confirm routing information according to the topology of the native IPv6 network, and then transmits the routing information to the 6to4 router 120 according to BGP protocol. Such routing information collection and transmission according to the topology of the native IPv6 network can be performed when a corresponding network is initially routed or the corresponding network undergoes topology change. In the meantime, such routing information collection and transmission can be performed according to other protocols that operate in a manner equivalent to those of the afore-described protocols.

The 6to4 relay router 140 can transmit the topology information of the native IPv6 network to the 6to4 router 120 by using the UPDATE message as shown in FIG. 3. In this case, the relay router 140 transmits some information which explains IGP type, through which corresponding routing information is acquired, and other information such as metric value and cost needed for reaching destinations according to IGP. The 6to4 router 120 can refer to such information and perform routing according to the topology of the native IPv6 network.

When connected to a new 6to4 router 120 or re-connected after disconnection, the 6to4 relay router 140 can transmit to the 6to4 router 120 routing information about a native IPv6 network contained in its RIB table.

Next the operation of the 6to4 router will be described.

The 6to4 router 120, upon receiving routing information of a native IPv6 network from a 6to4 relay router 140, combines IPv4 and IPv6 routes with respect to all IPv6 routes contained in the received routing information, selects an optimum route with respect to metric or cost values of equal routes, and then stores the optimum route in FIB. In this case, priority may be given based upon a selection value on the IPv4 and IPv6 networks to be used at the time of automatic route selection. Traffic headed for an IPv6 network selected in the 6to4 network is delivered to the 6to4 relay router 140, and stored in FIB.

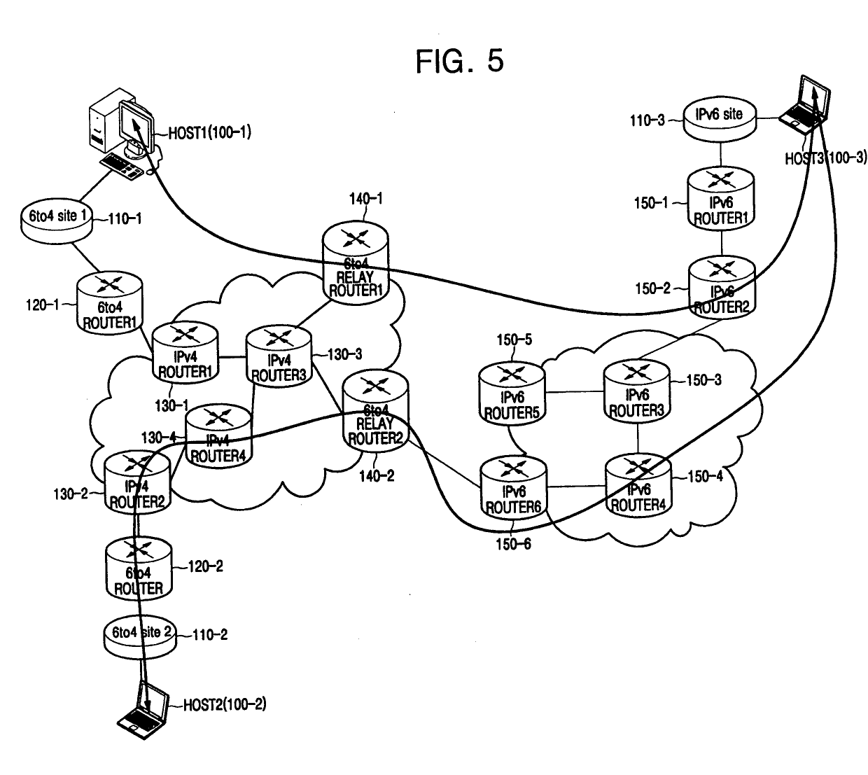

FIG. 5 illustrates a network system to which a routing apparatus capable of selecting an optimum route is applied according to the invention.

Components shown in FIG. 5 are also assumed to have network addresses as reported in Table 1 above.

Tables 4 and 5 show an example of routing information for route selection up to a host 100-3, which is ensured by a 6to4 router 120-1 and a 6to4 router 120-2 in FIG. 5 according to routing protocol (e.g., iBGP), when the components in FIG. 5 have the network addresses as reported in Table 1 above. In this case, metric values marked in Tables 4 and 5 are calculated based on the assumption that a metric value of “1” is assigned equally to all inter-router movement in the network system as shown in FIG. 5.

First, the selection of a route for traffic transmission from the host 100-1 to the host 100-3 will be described with reference to Table 4.

TABLE 4

| <BGP RIB> | prefix | nexthop | select rtype | metric |
|---|---|---|---|---|
| | 2ffe:0001::/32 | ::192.88.99.1 | RIP | 4 |
| | 2ffe:0001::/32 | ::192.88.99.2 | RIP | 5 |

| <IPv4 RIB> | prefix | nexthop | metric |
|---|---|---|---|
| | 192.88.99.1/32 | 11.11.11.1 | 3 |
| | 192.88.99.2/32 | 11.11.11.1 | 3 |

| <IPv6 RIB> | prefix | nexthop | interface |
|---|---|---|---|
| | 2ffe:0001::/32 | ::192.88.99.1 | 6to4 |

Table 4 shows an example of routing information which the 6to4 router 120-1 acquires in route selection from the host 100-1 to the host 100-3. Route selection or routing for traffic transmission from the host 100-1 to the host 100-3 will be described with reference to Table 4 and FIGS. 2 to 5. In this case, route selection can be performed by the 6to4 router 120-1.

Referring to Table 4, routing information according to the topology of the native IPv6 network contains metric values indicating that a metric value from the 6to4 relay router 140-1 to the host 100-3 is “4”, and that a metric value from the 6to4 relay router 140-2 to the host 100-3 is “5.” In this case, the information according to the topology of the native IPv6 network is collected by the 6to4 relay router 140-1 or 6to4 relay router 140-2 according to routing protocol, and is transmitted from the 6to4 relay router 140-1 or the 6to4 relay router 140-2 to the 6to4 router 120-1. Of course, the 6to4 relay router 140-1 or the 6to4 relay router 140-2 can transmit the routing information to the 6to4 router 120-2 according to the topology of the native IPv6 network. In this case, the routing information can be transmitted in a message having a format as shown in FIGS. 3 and 4.

Referring to Table 4 again, the routing information according to the topology of the 6to4 network contains metric values indicating that a metric value from the 6to4 router 120-1 to the 6to4 relay router 140-1 is “3”, and that a metric value from the 6to4 router 120-1 to the 6to4 relay router 140-2 is “3.” Such routing information is collected by the 6to4 router 120-1.

The 6to4 router 120-1 can select a route for traffic transmission from the host 100-1 to the host 100-3 by considering the routing information according to the topology of the 6to4 network collected by itself, and the routing information according to the topology of the native IPv6 network received from the 6to4 relay router 140-1 or the 6to4 relay router 140-2. The route selected as above passes through the 6to4 relay router 140-1.

Next, the selection of a route for traffic transmission from the host 100-2 to the host 100-3 will be described with reference to Table 5 below:

TABLE 5

| <BGP RIB> | prefix | nexthop | select rtype | metric |
|---|---|---|---|---|
| | 2ffe:0001::/32 | ::192.88.99.1 | RIP | 4 |
| | 2ffe:0001::/32 | ::192.88.99.2 | RIP | 5 |

| <IPv4 RIB> | prefix | nexthop | metric |
|---|---|---|---|
| | 192.88.99.1/32 | 33.33.33.1 | 4 |
| | 192.88.99.2/32 | 33.33.33.1 | 2 |

| <IPv6 RIB> | prefix | nexthop | interface |
|---|---|---|---|
| | 2ffe:0001::/32 | ::192.88.99.2 | 6to4 |

Table 5 shows an example of routing information acquired by the 6to4 router 120-2 when a route from the host 100-2 to the host 100-3 is selected. The route selection or routing for traffic transmission from the host 100-2 to the host 100-3 will be described with reference to Table 5 and FIGS. 2 to 5. In this case, such route selection can be performed by the 6to4 router 120-2.

As seen in Table 4, the routing information according to the topology of the native IPv6 network contains metric values indicating that a metric value from the 6to4 relay router 140-1 to the host 100-3 is “4”, and that a metric value from the 6to4 relay router 140-2 to the host 100-3 is “5.” In this case, such information according to the topology of the native IPv6 network is collected by the 6to4 relay router 140-1 or the 6to4 relay router 140-2 according to the routing protocol, and is transmitted from the 6to4 relay router 140-1 or the 6to4 relay router 140-2 to the 6to4 router 120-2. In this case, such routing information can be transmitted in a message having a format as shown in FIGS. 3 and 4.

Referring to Table 5 again, the routing information according to the topology of the 6to4 network contains metric values indicating that a metric value from the 6to4 router 120-2 to the 6to4 relay router 140-1 is “4”, and that a metric value from the 6to4 router 120-2 to the 6to4 relay router 140-2 is “2.” Such routing information is collected by the 6to4 router 120-2.

The 6to4 router 120-2 can select a route for traffic transmission from the host 100-2 to the host 100-3 by considering the routing information according to the topology of the 6to4 network collected by itself, and the routing information according to the topology of the native IPv6 network received from the 6to4 relay router 140-1 or the 6to4 relay router 140-2. The route selected as above passes through the 6to4 relay router 140-2.

According to the present invention, in the case of selecting a route on a 6to4 network according to IPv6 hosts on a native IPv6 network and dynamic routing protocol, route selection can be performed by considering both of IPv6 and IPv4 network topologies. As a result, efficient routing can be established between the 6to4 network and the IPv6 network.

Although preferred embodiments of the present invention have been described in detail, it will be appreciated by those skilled in the art to which the present invention pertains that several modifications and variations can be made without departing from the spirit and scope of the present invention as defined in the appended claims. Accordingly, future variations of the embodiments of the present invention can be covered by the technique of the present invention.

What is claimed is:

1. A routing apparatus for use in a 6to4 relay router which connects a native Internet Protocol version 6 (IPv6) network with a 6to4 network, and for selecting a route passing through the native IPv6 network and the 6to4 network, said apparatus comprising:
an information collector for collecting routing information of the native IPv6 network;
a message generator for generating a message including the collected routing information; and
a message transmitter for transmitting the message to a 6to4 router of the 6to4 network.

2. The routing apparatus according to claim 1, wherein the routing information of the native IPv6 network is collected by an Interior Gateway Protocol (IGP).

3. The routing apparatus according to claim 2, wherein the IGP comprises an Internal Border Gateway Protocol (iBGP).

4. The routing apparatus according to claim 1, wherein the message generated by the message generator comprises an expanded Border Gateway Protocol (BGP) message.

5. The routing apparatus according to claim 4, wherein the expanded BGP message further includes information indicating a type of a routing protocol used for the collection of the routing information of the native IPv6 network.

6. A routing apparatus for use in a 6to4 relay router which connects a native Internet Protocol version 6 (IPv6) network to a 6to4 network, and for selecting a route passing through the native IPv6 and 6to4 networks, said apparatus comprising:
a routing information collector for collecting routing information of the 6to4 network;
a message receiver for receiving routing information of the native IPv6 network from the 6to4 relay router which connects the native IPv6 network to the 6to4 network; and
a route selector for selecting a route for a network connected to the native IPv6 network and the 6to4 network according to the collected routing information of the 6to4 network and the received routing information of the native IPv6 network.

7. The routing apparatus according to claim 6, wherein the routing information of the native IPv6 network includes routes establishable by the native IPv6 network and metric values of the routes.

8. The routing apparatus according to claim 7, wherein the route selector selects a minimal metric value passing through the native IPv6 network and the 6to4 network.

9. A network system in which a route passing through a native IPv6 network and a 6to4 network is selected, said system comprising:
a 6to4 relay router located on a border between the native IPv6 network and the 6to4 network for collecting routing information of the native IPv6 network, and for transmitting the collected routing information; and
a 6to4 router located in the 6to4 network for receiving the routing information of the native IPv6 network as collected and transmitted by the 6to4 relay router, for collecting routing information of the 6to4 network, and for selecting a route for traffic transmission between the native IPv6 network and the 6to4 network according to the collected routing information of the 6to4 network and the received routing information of the native IP6 network.

10. The network system according to claim 9, wherein the 6to4 relay router collects the routing information of the native IPv6 network according to an Internal Gateway Protocol (IGP).

11. The routing apparatus according to claim 10, wherein the 6to4 relay router transmits the collected routing information of the native IPv6 network to the 6to4 router according to a Border Gateway Protocol (BGP).

12. A message used for transmitting routing information between a 6to4 router and a 6to4 relay router so as to select a route passing through a native IPv6 network and a 6to4 network, the message comprising a Border Gateway Protocol (BGP) update message which includes routing information of the native IPv6 network collected by the 6to4 relay router.

13. The message according to claim 12, further comprising routing protocol information used for collection of the routing information.

14. A routing method for selecting a route passing through a native IPv6 network and a 6to4 network, the method comprising the steps of:
(a) collecting routing information of the native IPv6 network;
(b) collecting routing information of the 6to4 network; and
(c) selecting the route passing through the native IPv6 network and the 6to4 network according to the routing information of the native IPv6 network and the routing information of the 6to4 network.

15. The routing method according to claim 14, wherein step (a) is performed by a 6to4 relay router which connects the native IPv6 network to the 6to4 network according to an IPv6 routing protocol.

16. The routing method according to claim 15, wherein the routing information is collected according to an Internal Gateway Protocol (IGP).

17. The routing method according to claim 14, wherein step (b) is performed by a 6to4 router of the 6to4 network according to an IPv4 routing protocol.

18. The routing method according to claim 14, wherein step (c) is performed by a 6to4 router of the 6to4 network.

19. The routing method according to claim 18, wherein the routing information of the native IPv6 network used in step (c) is received by the 6to4 router from a 6to4 relay router.

20. The routing method according to claim 18, wherein the routing information of the native IPv6 network is included in a Border Gateway Protocol (BGP) update message which the 6to4 router receives from a 6to4 relay router.
